(19) United States
(12) Patent Application Publication
(10) Pub. No.: US 2025/0110483 A1
(43) Pub. Date: Apr. 3, 2025

(54) GENERATING AND UTILIZING AN EXPLORATION ENVIRONMENT IN CONJUNCTION WITH A PRODUCTION ENVIRONMENT

(71) Applicant: Chime Financial, Inc., San Francisco, CA (US)

(72) Inventors: Ayushi Agarwal, Milpitas, CA (US); Han Wang, Newark, CA (US); Jing Cheng, Campbell, CA (US); Jingwei Yang, San Francisco, CA (US); Frank Teoh, Milpitas, CA (US); Peeyush Agarwal, Mountain View, CA (US)

(21) Appl. No.: 18/478,007

(22) Filed: Sep. 29, 2023

(51) Int. Cl. G05B 19/418

(52) U.S. Cl. CPC G05B 19/41865; G05B 2219/31343

(57) ABSTRACT

The present disclosure relates to systems, non-transitory computer-readable media, and methods for providing a secure development environment for developing computer models by utilizing an exploration environment in conjunction with a production environment. In particular, the disclosed systems provide a method for a client account to develop machine learning models securely and efficiently (e.g., access, generate, train, and activate) by utilizing a scalable exploration environment isolated from a production environment. Further, the disclosed systems can provide a system for the client account to utilize to convert the exploration model to a production model and activate the production model within the production environment. In this way, the disclosed systems provide a separation between the exploration environment and the production environment when testing models and thus constrain the impact of testing models to the production environment.

### BACKGROUND

Recent years have seen significant improvements in computer system environments utilized for generating and testing computer models for use within a production environment. For example, conventional computer systems can allocate computer resources and configure computer systems to provide multiple environments to test computer models. To illustrate, conventional systems can utilize system configuration parameters and generate production and non-production system environments to test, evaluate, and implement computer models. Despite recent advances, however, existing system environments continue to exhibit a number of technical deficiencies when utilizing multiple computer environments, particularly with regard to security, efficiency, and functionality.

As just suggested, conventional computer system modeling environments often do not provide a non-production environment that is securely isolated from a production environment. For example, on many existing systems, jobs running in a non-production environment can impact production by writing to production data repositories. In some conventional systems, jobs running in a non-production environment can access computer resources shared with production servers and bog down the production system through an excessive use of system resources. Indeed, in many cases, conventional systems create security vulnerabilities and create a system environment that negatively impacts outward facing production systems.

Furthermore, many conventional computer system modeling environments are inefficient. In particular, many conventional systems are not designed to efficiently provide and scale a dedicated non-production environment that is based on individual user accounts when creating, utilizing, and testing computer models. For example, conventional systems require user accounts to individually configure the necessary environment resources and the required packages for the user account, often both locally and on remote servers. Furthermore, conventional systems often require a user account to configure the individual tools and the software required for testing computer models in a non-production environment. Indeed, this duplicative need to configure the system for each user account can result in setup inaccuracies and a need for the repetitive testing of computer models. Thus, conventional systems often cause an increased burden on implementing devices which results in longer interaction times and additional computational burdens on the implementing devices.

In addition to the above-discussed disadvantages, many conventional systems are inflexible and fail to provide valuable functionality to user devices when testing computer models within the system environment. In particular, many conventional system environments provide only limited options for resource allocation. For example, many conventional systems provide support for standalone instances with fixed computing resources (e.g., memory and disks) with limited scalability for computer model testing. These standalone instances do not allow for model training techniques such as distributed training, parallel execution for feature selection, and/or hyperparameter tuning. In other cases, conventional systems provide shared configuration settings, package versions, and/or shared system credentials to test computer models. Such sharing does not allow for independent model settings when testing the individual computer models and can result in inadvertent changes by user devices to the shared system configuration that negatively impacts other user devices. Further, because of the limits of conventional systems, current computer system modeling environments can require client devices to perform additional steps to generate an appropriate environment, validate the shared system configuration, and/or wait for system resources to become available before testing computer models.

These along with additional problems and issues exist with regard to conventional computer system modeling environments.

### BRIEF SUMMARY

This disclosure describes one or more embodiments of systems, methods, and non-transitory computer readable storage media that provide and/or solve one or more of the foregoing or other problems in the art. In particular, the disclosed systems can provide a secure development environment for developing computer models by utilizing an exploration environment in conjunction with a production environment. For instance, the system provides a method for client devices to develop machine learning models securely and efficiently (e.g., access, generate, train, and activate) by utilizing a scalable exploration environment which is isolated from a production environment.

In particular, the disclosed systems can generate a production environment and an exploration environment. The disclosed systems can generate the production environment with a full access data connection to a primary data repository that includes full read access and full write access. Further, the disclosed systems can generate the exploration environment, associated with a client account, with a limited access data connection to a primary data repository (e.g., full read access and limited write access). To illustrate, the disclosed systems can generate an isolated exploration environment for a client account to utilize when building, training, and activating an exploration model. Further, the disclosed systems can provide a system for the client account to utilize to convert the exploration model to a production model and activate the production model within the production environment. In this way, the disclosed systems can provide a separation between the exploration environment and the production environment when testing models and thus constrain the impact of testing models to the production environment.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which an environment management system can operate in accordance with one or more embodiments.

FIG. 2 illustrates an overview of the environment management system generating an exploration environment and a production environment in accordance with one or more embodiments.

FIG. 3 illustrates an overview of activating an exploration model and converting the exploration model to a production model in accordance with one or more embodiments.

FIG. 4 illustrates an overview of utilizing components of the environment management system in accordance with one or more embodiments.

FIG. 5 illustrates utilizing an exploration verification score and/or a production verification score in accordance with one or more embodiments.

FIG. 6 illustrates a flowchart of a series of acts for activating an exploration model in accordance with one or more embodiments.

FIG. 7 illustrates a block diagram of an example computing device for implementing one or more embodiments of the present disclosure.

FIG. 8 illustrates a network environment of an environment management system in accordance with one or more embodiments.

### DETAILED DESCRIPTION

This disclosure describes one or more embodiments of an environment management system that provides a secure development environment for computer model testing by providing an isolated exploration environment for client accounts. For instance, the system provides a method for client accounts to securely and efficiently perform machine learning development steps to build, train, and activate models utilizing a scalable exploration environment isolated from the production environment. In particular, the disclosed systems can generate a production environment for running production models with a full access data connection to a primary data repository that includes full read access and full write access. The disclosed systems can further generate an exploration environment for a client account to utilize when building, training, and activating an exploration model. Moreover, the disclosed systems can generate an exploration environment associated with a client account with a limited access data connection to a primary data repository including full read access and limited write access. Further, the disclosed systems can provide a method to convert the exploration model to a production model and activate the production model within the production environment. In this way, the disclosed systems can provide a separation between the exploration environment and the production environment when testing models and thus constrain the impact of testing models to the production environment.

As just mentioned, in one or more embodiments, the environment management system generates both a production environment and an exploration environment for training and utilizing computer models. In one or more embodiments, the environment management system generates the exploration environment that includes a replica of the production environment in association with a client account. For example, the replica of the production environment can be an exact or near-exact copy of the live or production environment that replicates the infrastructure components of the production environment, including servers, networking configurations, storage systems, databases, and any other necessary components.

Furthermore, in some embodiments, the disclosed systems generate an exploration environment associated with a client account and provide access for the client account to a production environment feature store. To illustrate, in certain embodiments, the environment management system generates an exploration environment feature store and creates a feature data pipeline between the exploration environment and the production environment feature store. In one or more embodiments, the environment management system provides limited access for a client account to a production environment feature store. For example, the environment management system determines a computing resource load on the production feature store and throttles the access to the production environment feature store based on the computing resource load. To further illustrate, in certain embodiments, activating the exploration model within the production environment includes providing the exploration model with the full access data connection to the primary data repository and by providing unrestricted access to the production environment feature store.

To provide another illustration, in some embodiments, the environment management system generates an exploration verification score for the exploration model based on an impact to the exploration environment and converts the exploration model to a production model within the production environment based on the exploration verification score. In certain embodiments, the environment management system generates a production verification score of the exploration model based on an anticipated impact to the production environment and converts the exploration model to a production model based on the production verification score. In addition, in some implementations, the environment management system activates an exploration model within the exploration environment associated with the client account by provisioning computing resources based on a requirement specified by the client account and de-provisions the computing resources based on factors such as an amount of time or computing resource use.

The environment management system provides several advantages and benefits over conventional systems and methods. For instance, in one or more embodiments, the environment management system provides a secure exploration environment isolated from the production environment. For example, as discussed above, on many existing environments, jobs running in a non-production environment can impact production by writing to shared data repositories or utilizing shared system resources. In contrast, the environment management system provides a clean separation between the exploration environment and the production environment. In particular, the environment management system provides powerful read permissions with restricted write permissions to ensure safety, minimize system impact, and limit risk to the functioning of the production environment. For example, by isolating the exploration environment, the environment management system reduces the possible vectors of attack for a data breach and also limits security exposure in the event of an actual data breach of the exploration environment. Further, the environment management system provides granular account level permissions and greater visibility into how system resources are allocated. Thus, the environment management system protects the production environment from exploration environment model testing by utilizing an isolated environment with separate access restrictions.

Further, the environment management system operates more efficiently than conventional environment management systems by configuring the exploration environment for individual client accounts with the necessary software, libraries, and packages for the client accounts to test computer models with limited user involvement. Furthermore, the environment management system configures the individual client account credentials, tools, and environment resources required for testing computer models in the exploration environment with limited user involvement. The environment management system also facilitates transferring a model from the exploration environment to the production environment with limited model modification. For example, the exploration environment replicates the production environment in terms of infrastructure, software configuration, and network configuration which allows the environment management system to convert an exploration model to a production model with limited changes to the model. This, in turn, decreases the burden on implementing devices due to decreasing the computational load on the implementing devices.

In addition to the above-discussed advantages, the environment management system improves system functionality by coordinating the resource allocation for user devices in the system environment. For example, in certain embodiments, the environment management system runs multiple computing resources or interconnected nodes to form a cluster with auto-scaling capabilities (e.g., memory and disk) and provide scalable model testing environments for user devices. Furthermore, in one or more embodiments, the environment management system provides individual client account access to the exploration environment and generates individual client account configuration settings, system credentials, and resource capacity for testing of computer models. In one or more embodiments, the environment management system enables read access for client accounts in the exploration environment to production environment trained models, ECR images, and model details to enable model verification, testing, evaluation, and comparison workflows. In addition, the environment management system utilizes separate lifecycle polices to manage data in the exploration environment with stringent enforcement policies without affecting the lifecycle of models within the production environment. In this way, the environment management system automatically generates an appropriate environment for client account testing of computer models while isolating the exploration environment from the production environment through the use of a more functional environment setup and a greater client account customization.

As illustrated by the foregoing discussion, the present disclosure utilizes a variety of terms to describe features and benefits of the environment management system. Additional detail is now provided regarding the meaning of these terms.

As used herein, the term “production environment” refers to an operational and live environment where a software application, system, or model can be deployed and made available to end-users or customers. In particular, the production environment can represent the final stage of a software development lifecycle, where a model or application is made available to users and operates in a real-world setting. To illustrate, the production environment can employ redundant infrastructure, fault-tolerant systems, and resilient networking to limit downtime and maintain high availability.

Relatedly, as used herein, the term “exploration environment” refers to a computing environment utilized for testing and validating software applications, systems, and/or models before they are deployed to the production environment. In particular, the exploration environment is separate from the production environment and allows user devices to execute model tests, identify issues, and evaluate the functionality and stability of computer models. The exploration environment simulates the production environment but is isolated from the production environment to limit the impact of testing activities on the production environment. For example, the exploration environment provides a controlled environment where user devices can freely test models without affecting the production environment or disrupting the user experience. Furthermore, the exploration environment replicates the production environment resources, configuration, and network setup to ensure that model testing results are accurate and reflect the production environment.

As used herein, the term “limited access data connection” refers to a limited access data connection to the primary data repository including full read access to the primary data repository and limited write access to the primary data repository. In particular, with a limited access data connection the user device can only perform read operations or make limited modifications to the primary data repository. For example, the user device can retrieve or query the data of the primary data repository, view its contents, or read data elements, but the user device is restricted to performing only certain write operations (e.g., ml.test or ml.explore schema).

Furthermore, as used herein, the term “exploration model” refers to a non-production model utilized during the development and testing phases of a machine learning or other data science project. In particular, the exploration model can be used in the exploration environment to assess the performance, behavior, and suitability of different model architectures, algorithms, or approaches before finalizing a production-ready model. To illustrate, the environment management system tests the exploration model by making changes, experimenting with different techniques, and incorporating the changes to enhance model performance and evaluate the results.

Relatedly, as used herein, the term “production model” refers to a trained machine learning or software model that is prepared for deployment and use in real-world applications or systems. In particular, an exploration model can be converted to a production model after completing the training process, achieving specific performance metrics or objectives, and/or being validated to ensure accuracy and reliability. To illustrate, the environment management system provides a production model that is designed to seamlessly integrate with data pipelines and workflows, fit within the existing data processing infrastructure, and handle the data formats and requirements of the production environment.

Furthermore, as used herein, the term “feature store” refers to a repository or system that includes the storage, organization, and management of data features used in machine learning and data analysis workflows. In particular, the feature store provides a centralized location where user devices access and share curated features for model development, testing, and analysis. Relatedly, as used herein, the term “feature data pipeline” refers to a system pipeline or framework that allows for the automated and efficient flow of data from the production environment feature store to the exploration environment. In particular, the feature data pipeline involves a series of steps or processes that transport data from the feature store, ensuring the data reliability, quality, security, and accessibility.

Further, as used herein, the term “exploration verification score” refers to a metric or measure used to assess the performance, quality, or readiness of a model or system in an exploration environment. In particular, the exploration verification score is an evaluation conducted in the exploration environment utilized to validate and verify the functionality, behavior, or compliance of the model before it is deployed in the production environment. For example, the exploration verification score can be based on predefined test scenarios, criteria, or requirements that the model or system requires. The exploration verification score can be presented as a pass/fail result indicating whether the computer model meets the specified criteria. Alternatively, in certain embodiments, the exploration verification score utilizes a scoring system to provide a quantitative representation of the model's performance, compliance, or quality.

Relatedly, as used herein, the term “production verification score” refers to a metric or measure used to assess the performance, quality, or readiness of a model or system for deployment in a production environment. In particular, the production verification score can provide an indication of how well the model meets the required criteria and/or specifications to ensure its reliability, functionality, and suitability for use in the production environment. For example, in certain embodiments, the production verification score is based on predefined criteria or requirements that the model or system must satisfy such as functional specifications, performance benchmarks, compliance standards, security measures, user device guidelines, or other relevant factors depending on the nature of the model or system. For example, the production verification score can be a quantitative value, such as a numerical score or percentage, or a qualitative assessment, such as a descriptive rating or classification. To illustrate, the production verification score can be designed to provide a representation of the model's readiness or compliance with the specified criteria within a production environment.

As used herein, the term “provision” or “provisioning” refers to the process of allocating and configuring resources to make them available for use by a client account. In particular, provisioning can include allocating the necessary hardware, software, or network resources required by a computer model. For example, provisioning may involve providing an amount of system resources specified by the client account including servers, virtual machines, software applications, storage space, network connectivity, or software licenses. Relatedly, as used herein, the term “de-provisioning” refers to the process of disabling or removing resources that are no longer needed or are unused for a period of time. In particular, de-provisioning can include shutting down servers, deleting virtual machines, uninstalling software applications, de-allocating storage space, removing network access privileges, or removing software licenses.

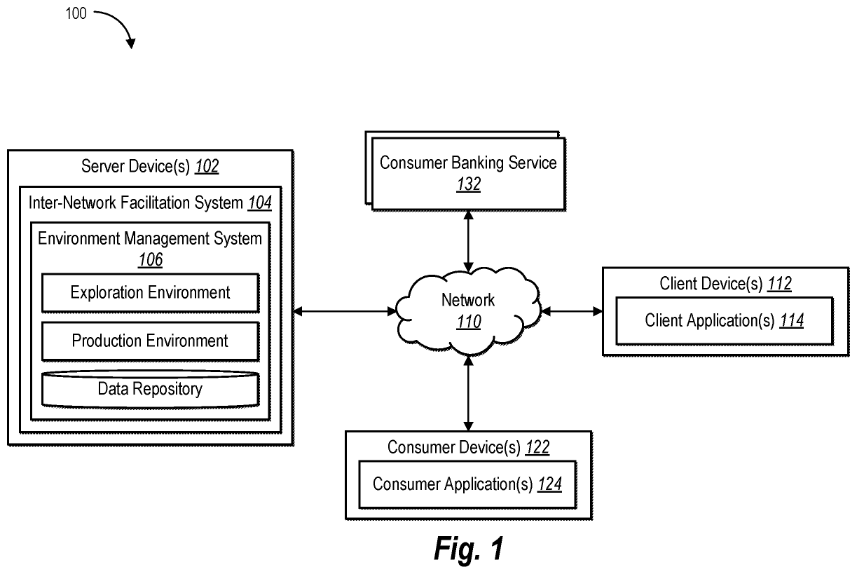

Additional detail will now be provided in relation to illustrative figures portraying example embodiments and implementations of the environment management system. For example, FIG. 1 illustrates a block diagram of an example embodiment of a system 100 for implementing an environment management system 106 in accordance with one or more embodiments. In general, and as illustrated in FIG. 1, the environment includes server device(s) 102 housing the environment management system 106 as part of an inter-network facilitation system 104. The environment of FIG. 1 further includes client device(s) 112, consumer banking service 132, and consumer device(s) 122. The server device(s) 102 communicate with the client device(s) 112, consumer device(s) 122, and consumer banking service 132 over a network 110. Further, the client device(s) 112 may also communicate with the consumer device(s) 122 and the consumer banking service 132 via the network 110.

As will be described in greater detail below, the server device(s) 102 can perform or provide various function, features, processes, methods, and systems as described herein. Additionally, or alternatively, the client device(s) 112 can perform or provide the various functions, features, processes, methods, and systems as described herein. In one or more embodiments, the server device(s) 102 and the client device(s) 112 coordinate together to perform or provide the various functions, features, processes, methods, and systems, as described in more detail below.

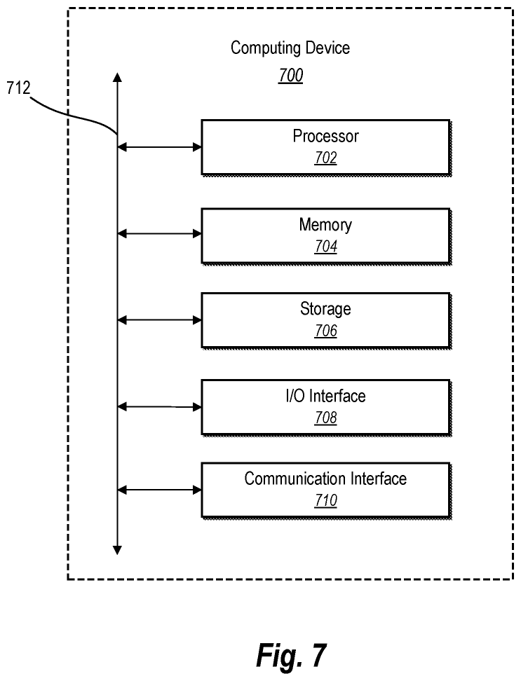

Generally, the client device(s) 112 can include any one of various types of client devices. For example, the client device(s) 112 can be a mobile device (e.g., a smart phone), tablet, laptop computer, desktop computer, or any other type of computing device as further explained below with reference to FIG. 7. Additionally, the client application(s) 114 can include any one of various types of client applications. For example, one or more of the client application(s) 114 can be a web browser, and users at the client device(s) 112 may enter a Uniform Resource Locator (URL) or other address directing the web browser to access the inter-network facilitation system 104 and/or environment management system 106 on the server device(s) 102. Alternatively, the client application can be a native application installed and executed on the client device(s) 112.

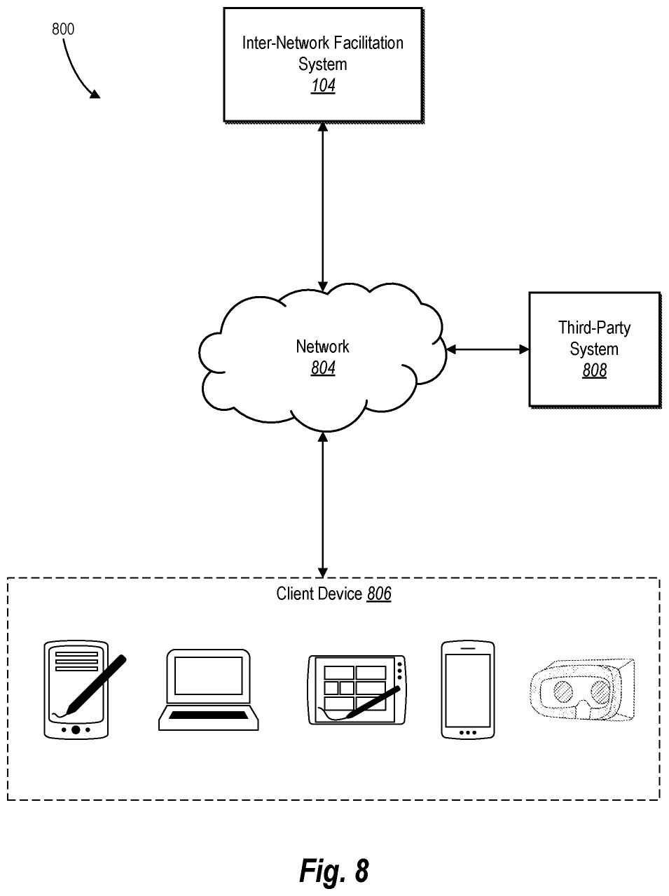

Additionally, the server device(s) 102 can include one or more computing devices including those explained below with reference to FIG. 7. The client device(s) 112, the server device(s) 102, and the network 110 may communicate using any communication platforms and technologies suitable for transporting data and/or communication signals, including any known communication technologies, devices, media, and protocols supportive of data communications, examples of which are described with reference to FIG. 8.

Generally, the consumer device(s) 122 can include any one of various types of user devices. For example, the consumer device(s) 122 can be a mobile device (e.g., a smart phone), tablet, laptop computer, desktop computer, or any other type of computing device. Additionally, the consumer application(s) 124 can include any one of various types of user applications. For example, one or more of the consumer application(s) 124 can be a web browser, and users at the consumer device(s) 122 may enter a Uniform Resource Locator (URL) or other address to access the consumer banking service 132. Alternatively, the user application can be a native application installed and executed on the consumer device(s) 122.

Although not a requirement, in one or more embodiments, the environment management system 106 can be part of the inter-network facilitation system 104. Accordingly, as shown in FIG. 1, the server device(s) 102 hosts the inter-network facilitation system 104, which includes the environment management system 106. The server device(s) 102 can include the exploration environment, the production environment, and the data repository to implement the environment management system 106. In one or more embodiments, the inter-network facilitation system 104 collects various types of data, including data provided by the consumer banking service 132 and provides the collected data to the environment management system 106. Further, in some embodiments, the environment management system 106 receives and utilizes models and configuration data from the client device(s) 112. In other embodiments, the server device(s) 102 can include a system other than the environment management system 106 for collecting, generating, accessing, or otherwise managing data. Additionally, the server device(s) 102 can receive data via the network 110 from the client device(s) 102, the consumer banking service 132, or from another source.

The consumer banking service 132 can correspond to a variety of systems that provide a variety of data that is utilized by the exploration environment, production environment, and data repository corresponding to the environment management system 106. To illustrate, the consumer banking service 132 can include systems that provide or maintain authentication data, consumer banking information, and a variety of other consumer system data. In one or more embodiments, the consumer banking service 132 provides data to the server device(s) 102 and the environment management system 106 via the network 110.

Although FIG. 1 illustrates the environment having a particular number and arrangement of components associated with environment management system 106, in some embodiments, the environment may include more or fewer components with varying configurations. For example, in some embodiments, the inter-network facilitation system 104 or environment management system 106 can communicate directly with the client device(s) 112, the consumer banking service 132, and/or the consumer device(s) 122, bypassing the network 110. In these or other embodiments, the inter-network facilitation system 104 or the environment management system 106 can be housed (entirely or in part) on the client device(s) 112. Additionally, the inter-network facilitation system 104 or the environment management system 106 can include (e.g., house) the client device(s) 112. Further, the inter-network facilitation system 104 can include more network components communicatively coupled together.

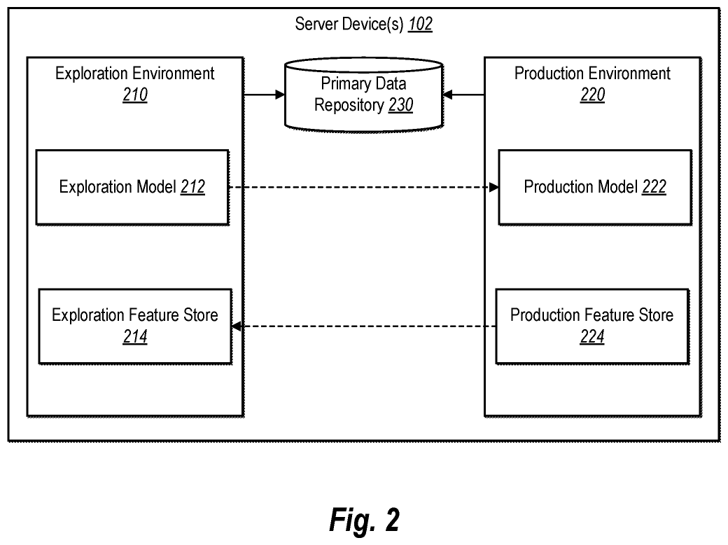

As indicated above, the inter-network facilitation system 104 or the environment management system 106 can generate an exploration environment and control the access of the exploration environment to a production environment and primary data repository. In particular, FIG. 2 illustrates an example overview of the environment management system generating an exploration environment and a production environment in accordance with one or more embodiments. Additional detail regarding the various acts illustrated in FIG. 2 is provided thereafter with reference to subsequent figures.

As illustrated in FIG. 2, in one or more embodiments, the environment management system 106 generates an exploration environment 210 with access to the primary data repository 230. For example, in one or more embodiments, the environment management system 106 generates the exploration environment 210, based on an individual client account, for running production models with a limited access data connection to the primary data repository 230 that includes full read access and limited write access to the primary data repository 230. To illustrate, the environment management system 106 provides full read access to the exploration environment 210 (and associated client account) by providing complete read visibility into all files, documents, databases, or resources within the primary data repository 230 without constraints. Further, the environment management system 106 provides limited write access to the exploration environment 210 (and associated client account) by providing limited write control to create, modify, and delete data within files, documents, databases, or resources within the primary data repository 230. To illustrate, the environment management system 106 can provide limited write access to exploration data in the primary data repository 230 and/or limited write access to the primary data repository 230 to exploration client accounts by utilizing specified static IP addresses (e.g., providing access based on client account and IP address).

Indeed, by utilizing a limited access data connection, the environment management system 106 limits unintended consequences to the production environment caused by errors within the exploration environment. For example, the environment management system 106 ensures that the exploration environment cannot overwrite production data or have an inadvertent effect on the efficacy of production services. Furthermore, by utilizing a limited access data connection, the environment management system 106 reduces the vector of attacks, decreases the potential blast radius, and shuts off the security exposure of the production environment due to a potential security breach.

As further illustrated in FIG. 2, in one or more embodiments, the environment management system 106 generates a production environment 220 with access to a primary data repository 230. For example, in one or more embodiments, the environment management system 106 generates the production environment 220 for running production models with a full access data connection to a primary data repository 230 that includes full read access and full write access to the primary data repository 230. As mentioned, the environment management system 106 provides full read access by providing complete read visibility into all files, documents, databases, or resources within the primary data repository 230 without constraints. Further, the environment management system 106 provides full write access by providing complete write control to create, modify, and delete data within files, documents, databases, or resources within the primary data repository 230.

Furthermore, as illustrated in FIG. 2, the environment management system 106 can generate an exploration model 212 within the exploration environment 210. For example, in one or more embodiments, the environment management system 106 generates, in association with the client account, the exploration environment 210 by generating a replica of the production environment and activating the exploration model within the exploration environment by activating the exploration model within the replica of the production environment. The exploration model 212 can be utilized during the development and testing phases of a machine learning or other data science project. In particular, the exploration model can be utilized within the exploration environment 210 to assess the performance, behavior, and suitability of different model architectures, algorithms, or approaches before finalizing a production-ready model within the production environment 220. The exploration model 212 has full read access to the primary data repository 230 and limited write access to the primary data repository 230. In particular, the exploration model 212 has powerful read permissions which facilitate exploratory model development using production environment data, but restricted write permissions which safeguard the dependability of the production environment data and limits the blast radius of failures to within the exploration environment 210.

As shown, in one or more embodiments, the environment management system 106 converts the exploration model 212 to a production model 222 within the production environment 220. The production model 222 has full read access to the primary data repository 230 and full write access to the primary data repository 230. In particular, the exploration model 212 is converted to the production model 222 after completing the training process, achieving specific performance metrics or objectives, and/or being validated to ensure accuracy and reliability. To illustrate, the environment management system 106 converts the exploration model 212 to the production model 222 and seamlessly integrates the production model 222 within the existing data processing infrastructure of the production environment 220 including the system, data, and environmental requirements of the production environment 220.

As further illustrated in FIG. 2, the environment management system 106 can generate a production feature store 224 within the production environment 220. The production feature store 224 serves as a repository for storing and managing machine learning features used in the development and deployment of production-grade machine learning models and applications. In particular, the feature store provides a centralized location where client accounts access curated features for model development, testing, and analysis. In addition, the environment management system 106 provides access to the production feature store 224 to the exploration environment 210. For example, in one or more embodiments, the exploration environment 210 includes an exploration feature store 214 which incorporates exploration features specific to the exploration environment 210 (e.g., used in the development and deployment of exploration models) and has read access to the production feature store 224 (e.g., full read access or limited read access). Moreover, in one or more embodiments, the exploration environment 210 has read access to the production feature store 224 independent of the exploration feature store 214.

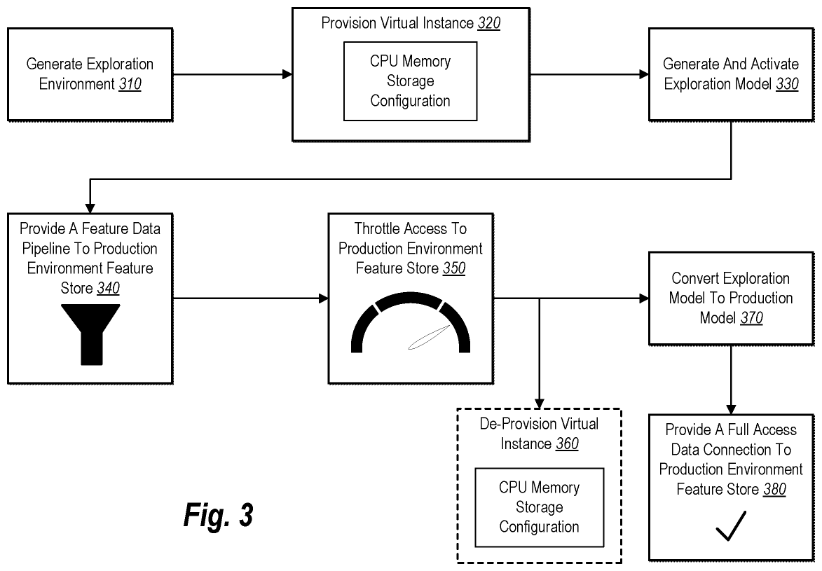

As mentioned, the environment management system 106 can generate exploration models and convert the exploration models to production models. For example, FIG. 3 illustrates an overview of activating an exploration model and converting the exploration model to a production model in accordance with one or more embodiments.

More specifically, as illustrated in FIG. 3, in one or more embodiments, the environment management system 106 performs the act 310 to generate an exploration environment. In particular, the environment management system 106 generates an exploration environment associated with a client account in which to generate, train, and activate machine learning models securely and efficiently. In particular, the environment management system 106 generates an environment associated with a client account by tailoring the computing environment for the client account within a larger system or platform. For example, the environment management system 106 generates the necessary configuration, system resources, and access permissions to model the production environment and/or based on the individual client account requirements, preferences, and roles. As mentioned, the exploration environment is a scalable environment that is isolated from the production environment.

Further, as illustrated in FIG. 3, the environment management system 106 performs act 320 to provision a virtual instance. In particular, the environment management system 106 performs act 320 to allocate and configure resources to make them available for use to a client account within the exploration environment. For example, act 320 can include allocating the necessary amount (or an amount requested by the client account) of hardware, software, or network resources required by a computer model. To illustrate, provisioning may involve providing necessary (or requested) resources such as CPU, memory, storage space, system configuration, servers, virtual machines, software applications, network connectivity, or software licenses.

As further shown, the environment management system 106 performs act 330 to generate and activate an exploration model. For example, the environment management system 106 generates, in association with a client account, an exploration environment comprising a limited access data connection to the primary data repository. As mentioned, the limited access data connection comprises the full read access to the primary data repository and a limited write access to the primary data repository. To illustrate, the environment management system 106 can generate an exploration machine learning model that can include one or more of decision trees, logistic regression models, support vector machines (SVMs), neural networks, random forests, and/or gradient boosting methods.

Moreover, in one or more embodiments the environment management system 106 performs the act 330 to generate the exploration environment for a specific client account. In particular, the environment management system 106 customizes exploration environment resources and packages to meet the preferences, requirements, and usage patterns of the client account. For example, the customization, configuration, tools, software, and access permissions are set according to the preferences and roles of the client account. Further, the environment management system 106 allocates computing resources (e.g., instances) that are based on the client account request such as specified, GPU, CPU, memory, processing, security (e.g., secrets), configuration, and storage. Indeed, the environment management system 106 can allocate computing resources to the client account associated with standardized environment management system 106 requirements and configurations, but customized to client account need.

Moreover, the environment management system 106 can activate the model within the exploration environment associated with the client account, wherein the exploration model accesses the primary data repository based on the limited access data connection for the exploration environment. For example, the environment management system 106 can activate the model by making the model available for training, inference, or prediction. In particular, activation can involve loading the model into memory and initializing any necessary dependencies or resources (e.g., CPU or GPU) to enable the model to process input data and generate output. To illustrate, the environment management system 106 can activate the model by feeding training data into the selected algorithm and allowing the model to learn patterns and relationships between the input features and output labels. The environment management system 106 can adjust the model's internal parameters iteratively to minimize the difference between its predicted outputs and the true labels in the training data. The environment management system 106 can also evaluate the model's performance using a validation set and adjust hyperparameters (e.g., learning rate, regularization) and model architecture to determine the best configuration for the model.

As further shown, the environment management system 106 can perform the act 340 to provide a feature data pipeline to the production environment feature store. For example, the environment management system 106 can provide limited access to the production environment feature store using a system pipeline or framework (e.g., feature data pipeline) that provides an efficient flow of data from the production environment feature store to the exploration environment. In particular, the feature data pipeline involves a series of steps or processes that transport production feature data from the production feature store to the exploration environment. By using a feature data pipeline to transport production feature data, the environment management system 106 ensures the data reliability, quality, security, and accessibility of the feature data in the production environment feature store.

As shown, the environment management system 106 performs the act 350 to throttle access to the production environment feature store. In particular, the environment management system 106 can impose limitations or restrictions on the rate or frequency at which users or systems can access and retrieve feature data from the store utilizing the feature data pipeline based on a computing resource load on the production environment or production environment feature store. For example, the environment management system 106 can determine a computing resource load indicative of the utilization or demand placed on computing resources such as the production environment feature store, CPU (Central Processing Unit), memory, disk storage, or network bandwidth within the production environment. Further, the environment management system 106 can utilize throttling mechanisms to control the flow of feature store requests to implementing controls and mechanisms to restrict the frequency or volume of requests made to the production environment feature store to prevent overloading or straining the underlying infrastructure or negatively impacting the performance and availability of the production environment.

For example, the environment management system 106 utilizes throttling to ensure efficient utilization of system resources, such as compute power, memory, and network bandwidth. By controlling the rate of access to the production environment feature store, the environment management system 106 prevents excessive consumption of resources, thereby ensuring appropriate resource allocation among client devices or systems and maintaining the overall performance and stability of the production environment. Further, by using throttling, the environment management system 106 prevents performance degradation or service disruptions caused by sudden spikes in traffic or excessive concurrent requests. By limiting the rate of access, the environment management system 106 allows the production environment feature store to handle requests within its capacity, avoiding bottlenecks, and maintaining consistent response times. In addition, throttling acts as a defense mechanism against malicious activities or abusive behavior. To illustrate, throttling access to the feature store protects the feature store from denial-of-service (DOS) attacks, brute-force attacks, or unauthorized access attempts. By limiting the rate of incoming requests, the environment management system 106 mitigates the risk of overwhelming the system and enhances overall security of the production environment.

As shown in FIG. 3, the environment management system 106 can optionally perform the act 360 to de-provision the virtual instance. In particular, the environment management system 106 can disable or remove the resources associated with the virtual instance that are no longer needed or have been unused for a period of time. In particular, de-provisioning can include shutting down servers, deleting virtual machines, uninstalling software applications, de-allocating storage space, removing network access privileges, or removing software licenses. For example, the environment management system 106 utilizes de-provisioning to ensure that unnecessary or obsolete resources are removed from the virtual instance, thereby reducing operational costs, improving security by eliminating potential security vulnerabilities, and optimizing resource allocation and management.

As further illustrated in FIG. 3, the environment management system 106 can perform the act 370 to convert the exploration model to a production model. In particular, the environment management system 106 can, based on a client account request, convert the exploration model to a production model within the production environment and provide access to the primary data repository based on the full access data connection for the production environment. For example, the environment management system 106 can seamlessly convert the exploration model into a production model within the production environment by integrating the production model with production data pipelines and workflows, fitting the production model within the existing data processing infrastructure, and otherwise enabling the production model within the requirements of the production environment. In addition, the environment management system 106 can perform the act 380 to provide a full access data connection to the production environment feature store. As mentioned, the environment management system 106 provides a full access data connection to the production model by providing unrestricted access (e.g., full read access and full write access) to the production environment feature store.

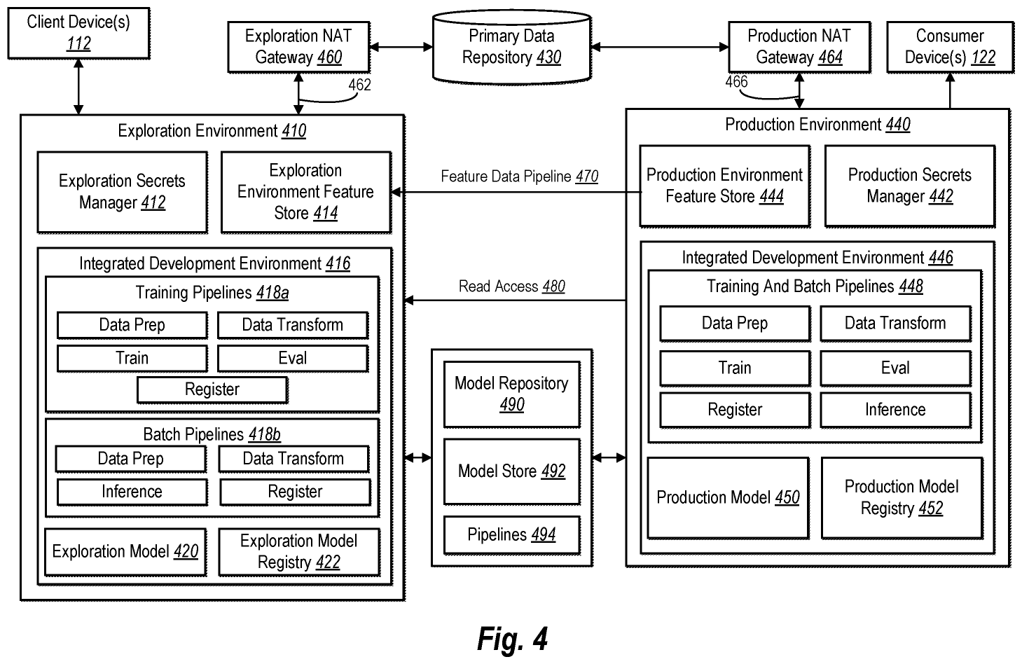

As mentioned, the environment management system 106 utilizes various components of an environment management system to generate an exploration environment 410 and a production environment 440. For example, FIG. 4 illustrates an example overview of utilizing the components of the environment management system in accordance with one or more embodiments.

As illustrated in FIG. 4, the environment management system 106 generates an exploration environment 410 and a production environment 440. As shown, the exploration environment 410 includes an exploration secrets manager 412, an exploration environment feature store 414, an integrated development environment 416. As shown, the production environment 440 includes a production secrets manager 442, a production environment feature store 444, an integrated development environment 446. As further shown, the environment management system 106 includes client device(s) 112, primary data repository 430, exploration NAT gateway 460, production NAT gateway 464, model repository 490, pipelines and model store 492, and pipelines 494.

As shown in FIG. 4, the environment management system 106 provides the exploration NAT gateway 460 for the exploration environment 410 to access the primary data repository 430. In particular, the exploration NAT gateway 460 enables the exploration environment 410 to access the network 110 by performing network address translation. The exploration NAT gateway 460 acts as an intermediary between a private/internal network and a public/external network by allowing multiple devices within the private network to share a single public IP address.

Furthermore, as mentioned in relation to FIG. 2, the environment management system 106 utilizes a limited access data connection 462 to connect to the primary data repository 430 which provides full read access to the primary data repository 230 and limited write access to the primary data repository 230.

As further shown in FIG. 4, the environment management system 106 provides the production NAT gateway 464 for the production environment 440 to access the primary data repository 430. In particular, the production NAT gateway 464 enables the exploration environment 410 to access the network 110 by performing network address translation. Similar to the discussion above, the production NAT gateway 464 acts as an intermediary between a private/internal network and a public/external network by allowing multiple devices within the private network to share a single public IP address. Furthermore, as mentioned in relation to FIG. 2, the environment management system 106 utilizes a full access data connection 466 to connect to the primary data repository 430 which provides full read access to the primary data repository 230 and limited write access to the primary data repository 230.

As shown in FIG. 4, the environment management system 106 provides access to the exploration environment 410 for the client device(s) 112. In particular, the environment management system 106 utilizes an exploration secrets manager 412 to control access to the exploration environment 410. For example, the environment management system 106 includes an exploration secrets manager 412 that is a specialized tool or service designed to securely store, manage, and control access to sensitive information or secrets within an exploration environment 410 infrastructure. For example, the environment management system 106 can provide a secrets manager to protect and control access to the exploration environment 410. To illustrate, the exploration secrets manager 412 provides a centralized and secure repository for storing and utilizing secrets such as passwords, API keys, database credentials, encryption keys, and other confidential data for the exploration environment 410.

Similarly, in one or more embodiments, the environment management system 106 includes a production secrets manager 442 that includes a specialized tool or service designed to securely store, manage, and control access to sensitive information or secrets within a production environment 440 infrastructure. For example, the production secrets manager 442 provides a centralized and secure repository for storing and utilizing secrets such as passwords, API keys, database credentials, encryption keys, and other confidential data for the production environment 440. Indeed, the environment management system 106 can provide a production secrets manager 442 to protect and control access to the production environment 440. Notably, by providing a production secrets manager 442 that is separate from the exploration secrets manager 412, the environment management system 106 can increase security through separate the access privileges for the production environment 440 and the exploration environment 410.

Furthermore, the environment management system 106 can generate an exploration environment feature store 414. The exploration environment feature store 414 provides a centralized location where user devices access and share curated features for model development, testing, and analysis within the exploration environment 410. The exploration environment feature store 414 is separate from the production environment feature store 444 and is used for development, testing, experimentation, or offline analysis within the exploration environment 410. The exploration environment feature store 414 provides dedicated feature data that allows data scientists and client accounts to work with feature data without impacting the operational systems or risking the integrity of production data within the production environment 440.

In addition, the environment management system 106 can include a production environment feature store 444. The production environment feature store 444 is a robust platform designed to store, manage, and serve feature data in the production environment 440. The production environment feature store 444 is designed to serve feature data to machine learning models and applications in real-time. To illustrate, in one or more embodiments, the production environment feature store 444 employs distributed and scalable architectures, leveraging technologies like distributed storage systems, caching mechanisms, and load balancing techniques. To illustrate, in one or more embodiments, the production environment feature store 444 incorporates mechanisms to monitor and track the quality and integrity of feature data such as data validation, anomaly detection, and data drift monitoring, allowing for early detection of data issues or changes that may impact the accuracy and performance of the production machine learning models relying on the feature data in the production environment 440.

As further shown in FIG. 4, the environment management system 106 can establish a connection or integration between the exploration environment 410 and the production environment 440 by generating a feature data pipeline 470 between the exploration environment feature store 414 and the production environment feature store 444. As mentioned, the feature data pipeline 470 is a pipeline or framework that provides access to the production environment feature store 444 for the exploration environment feature store 414 and/or the exploration environment 410. By utilizing the feature data pipeline 470 the environment management system 106 provides a pipeline for the exploration environment 410 to access and leverage the feature data stored in the production environment feature store 444 for development, testing, and experimentation purposes. To illustrate, the environment management system 106 can provide full read access, limited read access, and/or throttled read access to the production environment feature store 444 utilizing the feature data pipeline 470.

In addition, the environment management system 106 can provide read access 480 to the production environment 440 for the exploration environment 410. In particular, the environment management system 106 can provide read access to production environment data, including the production models 450, integrated development environment 446, production model registry 452, and the production secrets manager 442. For example, the environment management system 106 can provide read access 480 to allow the exploration environment 410 to generate and test the exploration model 420 utilizing production environment data while maintaining the integrity of the production environment data (e.g., by denying write access). To illustrate, the environment management system 106 can provide read access to production trained model artifacts, ECR images, model details, and model output to the exploration environment 410 to enable model verification, testing, evaluation and comparison related workflows.

As further shown in FIG. 4, the environment management system 106 includes an integrated development environment 416 within the exploration environment 410. The integrated development environment 416 provides a comprehensive set of tools and features to facilitate the development of the exploration model 420. For example, the integrated development environment 416 includes configuration options to set model structure, define model configuration, specify target platforms, and configure libraries or dependencies for model development. Similarly, the environment management system 106 includes an integrated development environment 446 within the production environment 440. The integrated development environment 446 includes configuration options to set model structure, define model configuration, specify target platforms, and configure libraries or dependencies for model development and activation.

Notably, the integrated development environment 416 includes an environment configuration that replicates key aspects of the integrated development environment 446. To illustrate, the environment management system 106 utilizes the integrated development environment 416 to provide a similar development experience to the integrated development environment 446 when performing machine learning tasks such as creating a pipeline, running training, processing and transforming jobs, and/or creating a serving endpoint. For example, client device(s) 112 configures deployment options within the integrated development environment 416 to mimic the deployment options within the integrated development environment 446. Furthermore, the environment management system 106 can be configured to provide a secure connection for the integrated development environment 416 and/or the integrated development environment 446 using by utilizing enhanced network security such as a private VPC subnet and/or an IP Allow-List.

Furthermore, in one or more embodiments the integrated development environment 416 differs from the integrated development environment 446 in key aspects. For example, the environment management system 106 can implement a separate lifecycle policy on the resources allocated to the client device(s) 112 utilizing the integrated development environment 416. To illustrate, the environment management system 106 can implement a 7-to-30-day lifecycle policy on the resources allocated to the client device(s) 112 and provide stringent enforcement to the lifecycle policy without affecting the production environment 440. Furthermore, the environment management system 106 can implement fine grain de-identification techniques to protect features/datasets within the integrated development environment 416. Indeed, due to the isolation of the exploration environment 410 from the production environment 440, the environment management system 106 can implement stringent controls and test configurations in a replica of the production environment 440 (e.g., exploration environment 410) without affecting the availability of the production environment 440 to consumer device(s) 122.

As shown in FIG. 4, the integrated development environment 416 includes training pipelines 418a. In particular, the integrated development environment 416 includes utilizing training pipelines 418a (e.g., training workflow) that include the stages of training a machine learning model. As shown, the training pipelines 418a include data preparation in which the data is cleaned and preprocessed to ensure it is in a suitable format for training the model. Further, the training pipelines 418a include data transformation to transform the data for the model including feature engineering, data normalization, handling missing values, and/or removing outliers. In addition, the training pipelines 418a include training the model using the prepared and transformed data, along with the target variable. For example, training the model involves selecting an appropriate algorithm, defining the model architecture, optimizing hyperparameters, and iteratively training the model on the training data. Further, the training pipelines 418a include evaluating the model using evaluation metrics and validation datasets to assess the model performance and generalization ability which identifies potential issues such as overfitting or underfitting and allows for model refinement and improvement. In addition, once the model meets the desired performance criteria, the training pipelines 418a include registering (e.g., saving) the model which can include persisting the model's parameters, weights, or configuration in the exploration model registry 422. To illustrate, the registered model is saved for future use by the environment management system 106, in which the environment management system 106 loads and reuses the registered model for inference tasks.

Furthermore, the integrated development environment 416 includes utilizing batch pipelines 418b to process large volumes of data in a batch-oriented manner by performing computations and analyses on historical or offline data. For example, the environment management system 106 utilizes a batch pipelines 418b to perform data preparation in which the data is cleaned and preprocessed to ensure it is in a suitable format for training the model. Further, the batch pipelines 418b include data transformation to transform the data for the model including feature engineering, data normalization, handling missing values, and/or removing outliers. In addition, the batch pipelines 418b include model inference in which the environment management system 106 applies the trained machine learning model to make predictions or perform computations on the batch data based on the learned patterns. Further, the batch pipelines 418b include model registration in the exploration model registry 422. To illustrate, the environment management system 106 can utilize the registered model by loading the registered model from the exploration model registry 422 to perform inference on batch data, generate predictions, or generate outputs based on the learned patterns.

As further illustrated in FIG. 4, the environment management system 106 includes training and batch pipelines 448. Similar to the discussion above regarding training pipelines 418a and batch pipelines 418b, the training and batch pipelines 448 utilize data preparation, data transformation, model training, model evaluation, model registration (in the production model registry 452), and model inference to train and utilize the production model 450.

In addition, the environment management system 106 includes a model repository 490. In particular, the environment management system 106 utilizes the model repository 490 to store, organize, and share machine learning models within the exploration environment 410 and/or the production environment 440. The environment management system 106 utilizes the model repository to provide controlled access to internal models that have been approved for internal use within the environment management system 106. Similarly, the environment management system 106 includes the model store 492. The environment management system 106 utilizes the model store to provide a curated collection of pre-trained machine learning models for use within the exploration environment 410 and/or the production environment 440. For example, the environment management system 106 utilizes the model store to provide a diverse selection of models covering different domains, tasks, and applications. As further illustrated, the environment management system 106 includes pipelines 494. In particular, the pipelines 494 provide a set of systematic flows or stages for training and utilizing the models within the exploration environment 410 and/or the production environment 440.

To illustrate, in one or more embodiments, client account associated with the client device(s) 112 requests to access the exploration environment 410. The environment management system 106 utilizes the exploration secrets manager 412 to determine whether to grant access to the exploration environment 410 to the client account. After receiving access to the exploration secrets manager 412, the client account further accesses the integrated development environment 416. Within the integrated development environment 416, the client account accesses the training pipelines 418a and/or the batch pipelines 418b. Further, the client account can access the model repository 490, the model store 492, the pipelines 494, the exploration environment feature store 414 as described above to access, modify, generate, and evaluate exploration models. In addition, the client account can utilize the feature data pipeline 470, the read access 480, and/or the limited access data connection 462 to the primary data repository 430 as described above. Moreover, the client account can update the exploration model registry 422, model repository 490, the model store 492, and the primary data repository to reflect changes to the exploration model. Further, the client account can update the pipelines 494 for further model training or inference for exploration models.

To further illustrate, in one or more embodiments, the environment management system 106 can execute production models within the production environment 440. In particular, the environment management system 106 utilizes the production secrets manager 442 to determine which accounts may access the production environment 440 to access, train, and execute production modes. Further, the environment management system 106 provides access to production environment 440 to the specified account(s). For example, the environment management system 106 permits a specified account to read model data, run data preparation, train the model, evaluate the model, register the model, and write inference within the integrated development environment 446. In addition, the specified account can access the full access data connection 466 to the primary data repository 430 as described above. Moreover, the specified account can update the exploration model registry 422, model repository 490, the model store 492, and the primary data repository to reflect changes to a production model. Further, the specified account can update the pipelines 494 for further production model training or inference. Notably, the environment management system 106 does not provide read access from the exploration environment 410 to the production environment 440 (e.g., feature data pipeline 470 or read access 480), thereby enhancing the security and independence of the production environment 440 while also maintaining the integrity of production environment data and services.

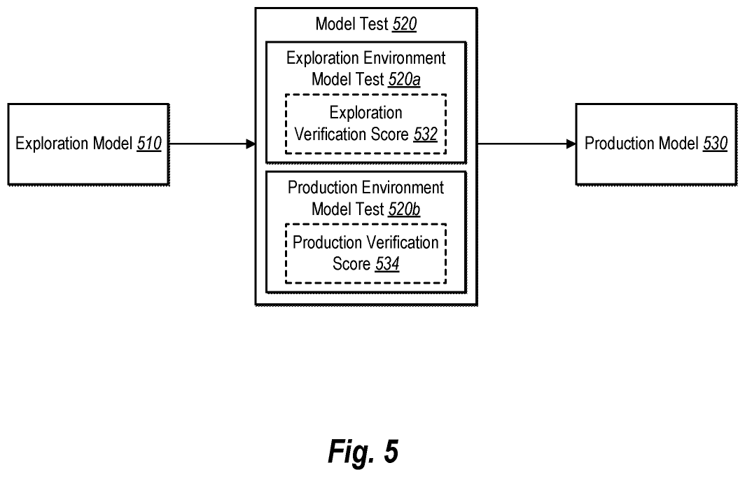

As mentioned, the environment management system 106 generates exploration models within an exploration environment and converts the exploration models to production models within a production environment. FIG. 5 illustrates utilizing an exploration verification score and/or a production verification score to convert the exploration models to production models in accordance with one or more embodiments.

As shown, the environment management system 106 generates an exploration model 510 in association with a client account within an exploration environment. Furthermore, the environment management system 106 performs a model test 520 of the exploration model 510. In particular, the environment management system 106 can perform the exploration environment model test 520a and/or the production environment model test 520b on the exploration model 510. The model test 520 refers to the process of evaluating the performance, accuracy, and behavior of the exploration model 510 before it is deployed into the production environment. The environment management system 106 utilizes the model test 520 to assess the model's effectiveness, identify potential issues or shortcomings, and make necessary improvements before deploying the model within the production environment.

As further shown, in one or more embodiments, the model test 520 can include the exploration environment model test 520a. For example, the exploration environment model test 520a is designed to evaluate various aspects, such as functional capabilities, performance benchmarks, compatibility, security measures, or any other relevant factors specific to the model or system being tested. The exploration environment model test 520a includes different types of testing, such as unit testing, integration testing, regression testing, system testing, or user acceptance testing.

As further shown, the environment management system 106 determines an exploration verification score 532 derived through the range of testing activities performed in the exploration environment model test 520a. The exploration verification score 532 can identify and address issues, bugs, or deficiencies in the exploration model 510 behavior and performance in the exploration environment. The exploration verification score 532 can be presented as a pass/fail result indicating whether the model meets the specified criteria or not. Alternatively, exploration verification score 532 utilizes a scoring system to provide a quantitative representation of the exploration model 510 performance, compliance, or quality. The exploration verification score 532 represents the exploration model 510 readiness for progression to the next development phase or for deployment in the production environment.

Notably, the environment management system 106 can obtain the exploration verification score 532 through an iterative process (and not a one-time assessment). The exploration verification score 532 can be tracked and evaluated at different stages of exploration model 510 development and deployment, allowing the environment management system 106 to facilitate continuous improvement and refinement of the exploration model 510 based on the results of the verification activities until the exploration model 510 meets specified standards and/or requirements.

As further shown, in one or more embodiments, the model test 520 can include the production environment model test 520b. For example, the environment management system 106 utilizes the production environment model test 520b to evaluate the performance and behavior of a machine learning model that is ready to be deployed and actively used in the production environment. The production environment model test 520b includes different types of testing, such as unit testing, integration testing, regression testing, system testing, or user acceptance testing.

As further shown, the environment management system 106 determines a production verification score 534 based on the anticipated impact to the production environment and derived through the range of testing activities performed in the production environment model test 520b. The production verification score 534 can identify and address issues, bugs, or deficiencies in the exploration model 510 behavior and performance in the production environment. For example, the production verification score 534 is derived through various testing and validation activities performed on the model in the production environment. The production environment model test 520b may involve functional testing, integration testing, performance testing, security testing, user acceptance testing, or any other relevant testing processes to evaluate different aspects of the exploration model 510 behavior and performance in the production environment. To illustrate, the production verification score 534 can be compared against predefined thresholds or acceptance criteria to determine whether the model meets the required standards for deployment in the production environment. To illustrate, these thresholds may be set based on environment management system 106 standards, industry standards, regulatory requirements, customer expectations, or internal quality standards.

Notably, the environment management system 106 can obtain the production verification score 534 on a continuing basis. In particular, the environment management system 106 can regularly (or at specified times) retest the exploration model 510 (or production model 530) using the production environment model test 520b on new data and evaluate the exploration model 510 (or production model 530) for ongoing accuracy and performance. In this way, the environment management system 106 can monitor the model's ongoing performance, detect any issues or anomalies, and ensure that the exploration model 510 (or production model 530) continues to deliver accurate and reliable results.

As further shown in FIG. 5, the environment management system 106 can generate a production model 530 based on the model test 520. In particular, based on the exploration verification score 532 and/or the production verification score 534, the environment management system 106 can convert the exploration model 510 to the production model 530.

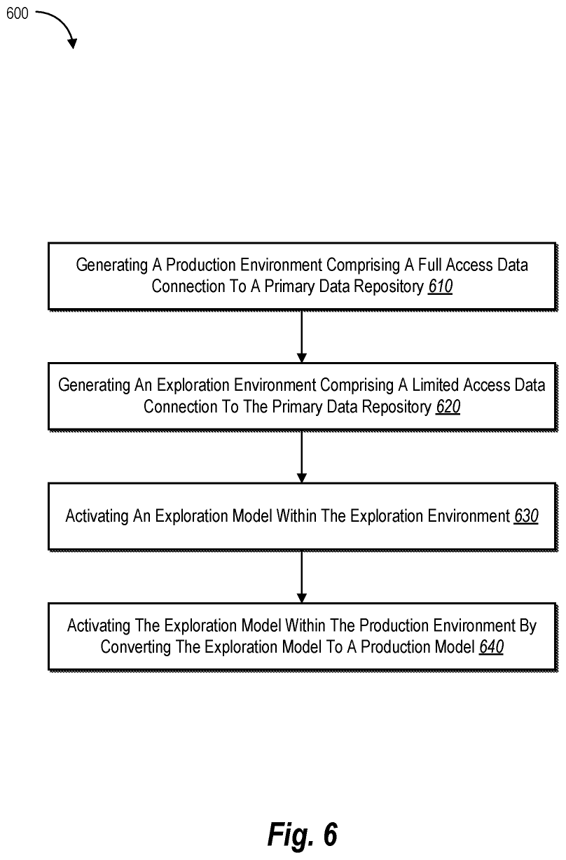

FIGS. 1-5, the corresponding text, and the examples provide a number of different methods, systems, devices, and non-transitory computer-readable media of the environment management system 106. In addition to the foregoing, one or more embodiments can also be described in terms of flowcharts comprising acts for accomplishing a particular result, as shown in FIG. 6. FIG. 6 may be performed with more or fewer acts. Further, the acts may be performed in differing orders. Additionally, the acts described herein may be repeated or performed in parallel with one another or parallel with different instances of the same or similar acts.

As mentioned, FIG. 6 illustrates a flowchart of a series of acts 600 for the environment management system 106 in accordance with one or more embodiments. While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer-readable medium can comprise instructions that, when executed by one or more processors, cause a computing device to perform the acts of FIG. 6. In some embodiments, the environment management system 106 can perform the acts of FIG. 6.

FIG. 6 illustrates a flowchart of a series of acts 600 for generating and utilizing an exploration environment in conjunction with a production environment in accordance with one or more embodiments. The series of acts 600 includes an act 610 of generating a production environment comprising a full access data connection to a primary data repository. In some embodiments, the act 610 comprises generating a production environment comprising a full access data connection to a primary data repository, wherein the full access data connection comprises a full read access and a full write access to the primary data repository.

The series of acts 600 further includes an act 620 of generating an exploration environment comprising a limited access data connection to the primary data repository. In some embodiments, the act 620 further includes generating, in association with a client account, an exploration environment comprising a limited access data connection to the primary data repository, wherein the limited access data connection comprises the full read access to the primary data repository and a limited write access to the primary data repository.

The series of acts 600 further includes the act 630 of activating an exploration model within the exploration environment. In some embodiments the act 620 further includes activating an exploration model within the exploration environment associated with the client account, wherein the exploration model accesses the primary data repository based on the limited access data connection for the exploration environment.

The series of acts 600 further includes the act 640 of activating the exploration model within the production environment by converting the exploration model to a production model. In some embodiments the act 640 further includes activating, based on a client account request, the exploration model within the production environment by converting the exploration model to a production model within the production environment, wherein the production model accesses the primary data repository based on the full access data connection for the production environment.

In addition (or in the alternative) to the acts described above, the environment management system series of acts 600 can include generating an exploration environment feature store and creating a feature data pipeline between the exploration environment and a production environment feature store. The series of acts 600 can also include determining a computing resource load on the production feature store and based on the computing resource load, throttling the feature data pipeline between the exploration environment and the production environment feature store. Moreover, in one or more embodiments, the series of acts 600 includes providing the exploration model with the full access data connection to the primary data repository and providing unrestricted access to the production environment feature store.

Further still, in some embodiments, the series of acts 600 includes generating, in association with the client account, the exploration environment further comprises generating a replica of the production environment. Furthermore, in one or more embodiments, the series of acts 600 includes activating the exploration model within the exploration environment by activating the exploration model within the replica of the production environment. Moreover, in certain embodiments, the series of acts includes generating an exploration verification score of the exploration model based on an impact on the exploration environment and converting the exploration model to a production model within the production environment based on the exploration verification score. Furthermore, in one or more embodiments, the series of acts 600 includes generating a production verification score of the exploration model based on an anticipated impact on the production environment and converting the exploration model to a production model based on the production verification score.

Furthermore, in one or more embodiments, the series of acts 600 includes activating an exploration model within the exploration environment associated with the client account by provisioning an amount of computing resources based on a requirement specified by the client account. In addition, in certain embodiments, the series of acts 600 includes de-provisioning the amount of computing resources after a specified amount of time.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 7 illustrates, in block diagram form, an exemplary computing device 700 that may be configured to perform one or more of the processes described above. One will appreciate that the environment management system 106 (or the inter-network facilitation system 104) can comprise implementations of a computing device, including, but not limited to, the devices or systems illustrated in the previous figures. As shown by FIG. 7, the computing device can comprise a processor 702, memory 704, a storage device 706, an I/O interface 708, and a communication interface 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, storage device 706 can comprise a non-transitory storage medium described above. The storage device 706 may include a hard disk drive (“HDD”), flash memory, a Universal Serial Bus (“USB”) drive or a combination of these or other storage devices.

The computing device 700 also includes one or more input or output (“I/O”) interface 708, which are provided to allow a user (e.g., requester or provider) to provide input to (such as user strokes), receive output from, and otherwise transfer data to and from the computing device 700. These I/O interface 708 may include a mouse, keypad or a keyboard, a touch screen, camera, optical scanner, network interface, modem, other known I/O devices or a combination of such I/O interface 708. The touch screen may be activated with a stylus or a finger.

The I/O interface 708 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 708 is configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 can provide one or more interfaces for communication (such as, for example, packet-based communication) between the computing device and one or more other computing devices 700 or one or more networks. As an example, and not by way of limitation, communication interface 710 may include a network interface controller (“NIC”) or network adapter for communicating with an Ethernet or other wire-based network or a wireless NIC (“WNIC”) or wireless adapter for communicating with a wireless network, such as a WI-FI. The computing device 700 can further include a bus 712. The bus 712 can comprise hardware, software, or both that couples components of computing device 700 to each other.

FIG. 8 illustrates an example network environment 800 of the inter-network facilitation system 104. The network environment 800 includes a client device 806 (e.g., client device(s) 112), an inter-network facilitation system 104, and a third-party system 808 (consumer banking service 132) connected to each other by a network 804. Although FIG. 8 illustrates a particular arrangement of the client device 806, the inter-network facilitation system 104, the third-party system 808, and the network 804, this disclosure contemplates any suitable arrangement of client device 806, the inter-network facilitation system 104, the third-party system 808, and the network 804. As an example, and not by way of limitation, two or more of client device 806, the inter-network facilitation system 104, and the third-party system 808 communicate directly, bypassing network 804. As another example, two or more of client device 806, the inter-network facilitation system 104, and the third-party system 808 may be physically or logically co-located with each other in whole or in part.

Moreover, although FIG. 8 illustrates a particular number of client devices 806, inter-network facilitation system 104, third-party systems 808, and networks 804, this disclosure contemplates any suitable number of client devices 806, inter-network facilitation system 104, third-party systems 808, and networks 804. As an example, and not by way of limitation, network environment 800 may include multiple client devices 806, inter-network facilitation system 104, third-party systems 808, and/or networks 804.

This disclosure contemplates any suitable network 804. As an example, and not by way of limitation, one or more portions of network 804 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 804 may include one or more networks 804.

Links may connect client device 806, inter-network facilitation system 104 (e.g., which hosts the environment management system 106), and third-party system 808 to network 804 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, the client device 806 may be an electronic device including hardware, software, or embedded logic components or a combination of two or more such components and capable of carrying out the appropriate functionalities implemented or supported by client device 806. As an example, and not by way of limitation, a client device 806 may include any of the computing devices discussed above in relation to FIG. 8. A client device 806 may enable a network user at the client device 806 to access network 804. A client device 806 may enable its user to communicate with other users at other client devices 806.

In particular embodiments, the client device 806 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 806 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 806 one or more Hyper Text Markup Language (“HTML”) files responsive to the HTTP request. The client device 806 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 804) to link the third-party-system 808. For example, the inter-network facilitation system 104 may receive authentication credentials from a user to link a third-party system 808 such as an online bank account, credit account, debit account, or other financial account to a user account within the inter-network facilitation system 104. The inter-network facilitation system 104 can subsequently communicate with the third-party system 808 to detect or identify balances, transactions, withdrawal, transfers, deposits, credits, debits, or other transaction types associated with the third-party system 808. The inter-network: facilitation system 104 can further provide the aforementioned or other financial information associated with the third-party system 808 for display via the client device 806. In some cases, the inter-network facilitation system 104 links more than one third-party system 808, receiving account information for accounts associated with each respective third-party system 808 and performing operations or transactions between the different systems via authorized network connections.

In particular embodiments, the inter-network facilitation system 104 may interface between an online banking system and a credit processing system via the network 804. For example, the inter-network facilitation system 104 can provide access to a bank account of a third-party system 808 and linked to a user account within the inter-network facilitation system 104. Indeed, the inter-network facilitation system 104 can facilitate access to, and transactions to and from, the bank account of the third-party system 808 via a client application of the inter-network facilitation system 104 on the client device 806. The inter-network facilitation system 104 can also communicate with a credit processing system, an ATM system, and/or other financial systems (e.g., via the network 804) to authorize and process credit charges to a credit account, perform ATM transactions, perform transfers (or other transactions) across accounts of different third-party systems 808, and to present corresponding information via the client device 806.

In particular embodiments, the inter-network facilitation system 104 includes an exploration model. For example, the inter-network facilitation system 104 includes a exploration model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 808), the inter-network facilitation system 104 can exploration model to generate a prediction (e.g., a percentage likelihood) of a transaction related result (e.g., a withdrawal, a transfer, or a purchase) across one or more networked systems.

The inter-network facilitation system 104 may be accessed by the other components of network environment 800 either directly or via network 804. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 806, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 804.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 806. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 806. Information may be pushed to a client device 806 as notifications, or information may be pulled from client device 806 responsive to a request received from client device 806. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 806 associated with users.

In addition, the third-party system 808 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 804. A third-party system 808 can communicate with the inter-network facilitation system 104 to provide financial information pertaining to balances, transactions, and other information, whereupon the inter-network facilitation system 104 can provide corresponding information for display via the client device 806. In particular embodiments, a third-party system 808 communicates with the inter-network facilitation system 104 to update account balances, transaction histories, credit usage, and other internal information of the inter-network facilitation system 104 and/or the third-party system 808 based on user interaction with the inter-network facilitation system 104 (e.g., via the client device 806). Indeed, the inter-network facilitation system 104 can synchronize information across one or more third-party systems 808 to reflect accurate account information (e.g., balances, transactions, etc.) across one or more networked systems, including instances where a transaction (e.g., a transfer) from one third-party system 808 affects another third-party system 808.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating a production environment comprising a full access data connection to a primary data repository, wherein the full access data connection comprises a full read access and a full write access to the primary data repository;
generating, in association with a client account, an exploration environment comprising a limited access data connection to the primary data repository, wherein the limited access data connection comprises the full read access to the primary data repository and a limited write access to the primary data repository;
activating an exploration model within the exploration environment associated with the client account, wherein the exploration model accesses the primary data repository based on the limited access data connection for the exploration environment; and
activating, based on a client account request, the exploration model within the production environment by converting the exploration model to a production model within the production environment, wherein the production model accesses the primary data repository based on the full access data connection for the production environment.

2. The computer-implemented method of claim 1, further comprising:
generating an exploration environment feature store; and
creating a feature data pipeline between the exploration environment and a production environment feature store.

3. The computer-implemented method of claim 2, further comprising:
determining a computing resource load on the production environment feature store; and
based on the computing resource load, throttling the feature data pipeline between the exploration environment and the production environment feature store.

4. The computer-implemented method of claim 1, wherein activating the exploration model within the production environment further comprises providing the exploration model with the full access data connection to the primary data repository and by providing unrestricted access to a production environment feature store.

5. The computer-implemented method of claim 1, wherein:
generating, in association with the client account, the exploration environment further comprises generating a replica of the production environment; and
activating the exploration model within the exploration environment comprises activating the exploration model within the replica of the production environment.

6. The computer-implemented method of claim 1, further comprising:
generating an exploration verification score of the exploration model based on an impact on the exploration environment; and
converting the exploration model to a production model within the production environment based on the exploration verification score.

7. The computer-implemented method of claim 1, further comprising:
generating a production verification score of the exploration model based on an anticipated impact on the production environment; and
converting the exploration model to a production model based on the production verification score.

8. The computer-implemented method of claim 1, further comprising:
activating an exploration model within the exploration environment associated with the client account by provisioning an amount of computing resources based on a requirement specified by the client account; and
de-provisioning the amount of computing resources after a specified amount of time.

9. A non-transitory computer-readable medium storing instructions that, when executed by at least one processor, cause a computing device to:
generate a production environment comprising a full access data connection to a primary data repository, wherein the full access data connection comprises a full read access and a full write access to the primary data repository;
generate, in association with a client account, an exploration environment comprising a limited access data connection to the primary data repository, wherein the limited access data connection comprises the full read access to the primary data repository and a limited write access to the primary data repository;
activate an exploration model within the exploration environment associated with the client account, wherein the exploration model accesses the primary data repository based on the limited access data connection for the exploration environment; and
activate, based on a client account request, the exploration model within the production environment by converting the exploration model to a production model within the production environment, wherein the production model accesses the primary data repository based on the full access data connection for the production environment.

10. The non-transitory computer-readable medium of claim 9, further comprising instructions that, when executed by the at least one processor, cause the computing device to:
generate an exploration environment feature store; and
create a feature data pipeline between the exploration environment and a production environment feature store.

11. The non-transitory computer-readable medium of claim 10, further comprising instructions that, when executed by the at least one processor, cause the computing device to:
determine a computing resource load on the production environment feature store; and
based on the computing resource load, throttle the feature data pipeline between the exploration environment and the production environment feature store.

12. The non-transitory computer-readable medium of claim 9, wherein activating the exploration model within the production environment further comprises providing the exploration model with the full access data connection to the primary data repository and by providing unrestricted access to a production environment feature store.

13. The non-transitory computer-readable medium of claim 9, further comprising instructions wherein generating, in association with the client account, the exploration environment further comprises generating a replica of the production environment and activating the exploration model within the exploration environment comprises activating the exploration model within the replica of the production environment.

14. The non-transitory computer-readable medium of claim 9, further comprising instructions that, when executed by the at least one processor, cause the computing device to:
generate an exploration verification score of the exploration model based on an impact on the exploration environment; and
convert the exploration model to a production model within the production environment based on the exploration verification score.

15. The non-transitory computer-readable medium of claim 9, further comprising instructions that, when executed by the at least one processor, cause the computing device to:
generate a production verification score of the exploration model based on an anticipated impact on the production environment; and
convert the exploration model to a production model based on the production verification score.

16. A system comprising:
at least one processor; and
at least one non-transitory computer-readable storage medium storing instructions that, when executed by at least one processor, cause the system to:
generate a production environment comprising a full access data connection to a primary data repository, wherein the full access data connection comprises a full read access and a full write access to the primary data repository;
generate, in association with a client account, an exploration environment comprising a limited access data connection to the primary data repository, wherein the limited access data connection comprises the full read access to the primary data repository and a limited write access to the primary data repository;
activate an exploration model within the exploration environment associated with the client account, wherein the exploration model accesses the primary data repository based on the limited access data connection for the exploration environment; and
activate, based on a client account request, the exploration model within the production environment by converting the exploration model to a production model within the production environment, wherein the production model accesses the primary data repository based on the full access data connection for the production environment.

17. The system of claim 16, further comprising instructions that, when executed by the at least one processor, cause the system to:
generate an exploration environment feature store;
create a feature data pipeline between the exploration environment and a production environment feature store;
determine a computing resource load on the production environment feature store; and
based on the computing resource load, throttle the feature data pipeline between the exploration environment and the production environment feature store.

18. The system of claim 16, wherein activating the exploration model within the production environment further comprises providing the exploration model with the full access data connection to the primary data repository and by providing unrestricted access to a production environment feature store.

19. The system of claim 16, further comprising instructions that, when executed by the at least one processor, cause the system to activate an exploration model within the exploration environment associated with the client account by provisioning an amount of computing resources based on a requirement specified by the client account.

20. The system of claim 19, further comprising instructions that, when executed by the at least one processor, cause the system to de-provision the amount of computing resources after a specified amount of time.
